(19) United States
(12) Patent Application Publication
(10) Pub. No.: US 2004/0182848 A1
(43) Pub. Date: Sep. 23, 2004

(54) Process, plant and bitumen-polymer based strip for surface and environmental heating of building structures and infrastructures

(76) Inventor: Aldo Stabile, Crema (IT)

Correspondence Address: Striker Striker & Stenby, 103 East Neck Road, Huntington, OH, 11743, US

(21) Appl. No.: 10/481,553

(22) PCT Filed: Aug. 6, 2001
(86) PCT No.: PCT/IT01/00432

(30) Foreign Application Priority Data
Jul. 9, 2001 (IT) MI2001A001454

(51) Int. Cl. H05B 3/10

(52) U.S. Cl. 219/213; 219/548

(57) ABSTRACT

Process for surface and environmental heating of building structures and infrastructures obtained by formation of a thermoelectric layer (210) placed behind the surface finish of walls and especially underneath the flooring of structures, by means of a polymer-bitumen strip with a metal core of extremely high electric conductivity, of a constant section and micrometric thickness, laid in lengths side by side sufficiently spaced for electrical insulation, by the ends of each length being bent back in a double bend (214) at 45°, thus permitting, by closure of said metal core in an electric circuit, transformation of electric energy into thermal energy.

The invention concerns the heating of building structures and infrastructures.

Innumerable processes and means at present exist for surface and environmental heating, essentially based on combustion especially of gases and on electric resistances.

In the first case the most widely used system is that of the thermosiphon with a central heater and radiators placed in the various rooms of a building.

In the second case electric current circulating in electric resistances is transformed into thermal energy.

These resistances reach very high temperatures, even 1000° C, distributing heat by radiation and by the convective movement of air. In all cases considerable heat losses take place along the thermal chain due to the difference between temperature of the flame or of the resistances and that of the environment, and especially because there is no real possibility of integrating the physico-mechanical structures of the heating plant with those to be heated, or of creating building structures themselves able to generate heat.

The amount of energy used compared with that consumed is therefore low.

The above invention solves or greatly reduces these problems as will now be explained.

Subject of the invention is a process, a plant and a bitumen-based strip for heating the surface areas and environments of building structures and infrastructures.

Behind the coating of the walls and especially underneath the floors of these structures, a thermoelectric layer is formed consisting of lengths, laid side by side and sufficiently spaced for electrical insulation, of a bitumen-based strip having a metal core of very high electrical conductivity, of a constant section and micrometric thickness, the whole, within a closed electric circuit, transforming electric energy into thermal energy.

In one type of execution these lengths are formed by folding back on each one a piece of strip, bent at 45° in relation to its axis, so as to form a quadrangular spiral.

In one type of execution each length of strip is bent back with a double 45° bend in relation to its axis so as to form a serpentine.

The final piece of strip presents a portion bent back on itself at 45° so that the ultimate end is only a short distance from the starting end to facilitate contact to a source of electricity.

The lengths laid side by side can consist of pieces of the strip.

These pieces can become U-shaped by making a double 45° bend. The lengths are electrically connected in parallel or in series.

Connection, at the end of the metal core of the thermoelectric layer with the lengths of strip placed by side, to the source of electric current, is obtained by removing from said ends of the core the bituminous material using heat and mechanical means to do so.

To ensure stable electrical connection it is preferable to fit onto the ends of the core an oblong type of clamp formed of a pair of rectangular metal plates of equal length.

The thickness of one longitudinal half of the first plate. is increased to an extent corresponding substantially to the thickness of the strip.

Thickness of the second plate is constant but its width is greater than that of the first.

Said clamp can be applied to the ends of the strip by rivets or equivalent means, making the strip comprising its bitumenous body, correspond to the longitudinal area of lesser thickness of the first plate and simultaneously making the metal core of the strip correspond to the longitudinal area of greater thickness of said first plate.

A part of one plate projects outwards for connection, by means of a terminal, to an electric wire.

The bitumen polymer is advantageously applied over an impregnable reinforcement placed on either surface of the metal core.

Said reinforcement may. be of polyester fibre on one surface and of fibreglass on the other, or else of fibreglass on both surfaces.

The reinforcement may be of spunbonded fabric on both surfaces or of fibreglass on one and spunbonded fabric on the other.

Advantageously the bitumen is a polymer bitumen associated to elastomers or plastomers, or to both.

Advantageously electric power is comprised between 30 and 50 Watt/m² while voltage is not greater than 12 Volt.

Advantageously the metal core can be connected to the source of electric current through a computer to program and automate, in the area of application to the structures and to the infrastructures, the most suitable values of temperature and heating time for the prevailing environmental conditions.

In one type of execution the thermoelectric layer is placed under the covering of practically any kind of flooring for indoor purposes.

In one type of execution the thermoelectric layer is placed underneath the paving blanket of an airport runway.

In one type of execution the thermoelectric layer is placed underneath the surface of roadways generally whether in the open air or in tunnels.

In one type of execution the thermoelectric layer is placed under the tiles and roofing generally of buildings.

In one type of execution the thermoelectric layer is inserted below the earth of plants used to form the grassy surface of football fields. Advantageously the thickness of the thermoelectric layer lies between two and four millimetres.

The metal core may be of aluminium or of copper.

The invention offers evident advantages.

As the case may require, surface heating for roads, runways, sports fields and for outdoor environments in general is made possible, as well as heating for indoor spaces by transforming the floors and walls of building structures or infrastructures into means for generating diffused warmth.

By means of the bitumen-polymer based strip, more like an object for the building trade than one of a physico-mechanical nature since it substantially consists of “reinforced bitumen”, the generator of heat can be almost totally integrated with building structures.

These structures themselves become generators of heat at temperatures only slightly above those required for indoor areas.

All this is made possible by a greatly increased level of efficiency, a further possibility being that of heating environments where this cannot be done at present for structural or economic reasons.

Characteristics and purposes of the disclosure will be made still clearer by the following examples of its execution illustrated by diagrammatically drawn figures.

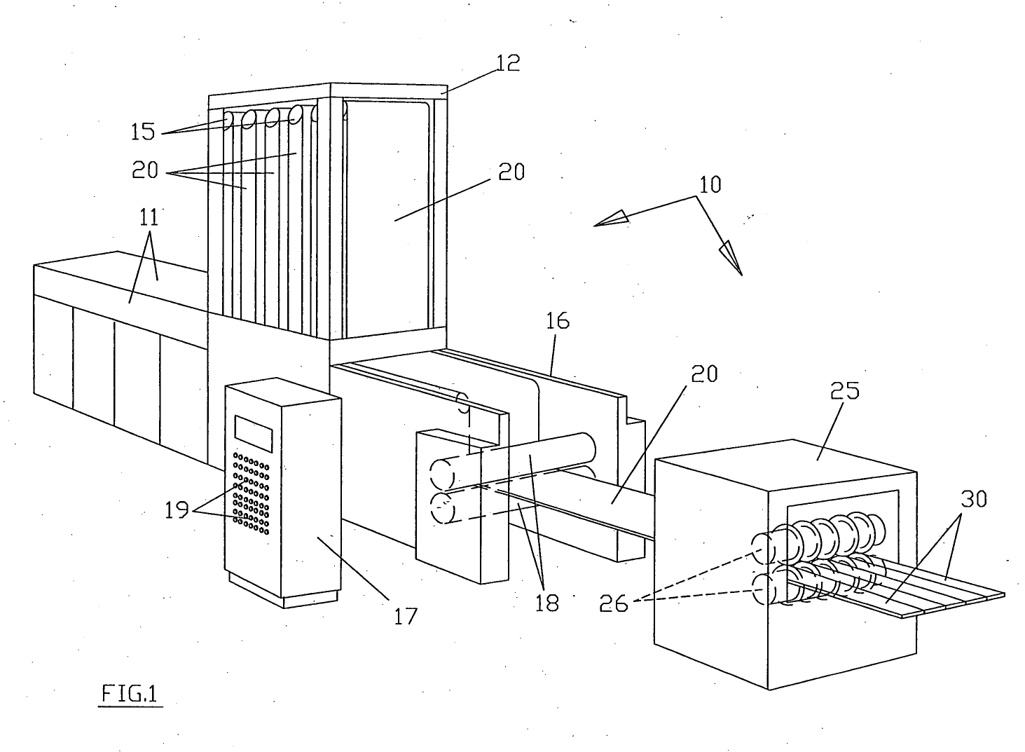

FIG. 1 Layout of an installation for production of polymer-bitumen strips containing a core of extremely high electrical conductivity, subject of the invention, perspective view.

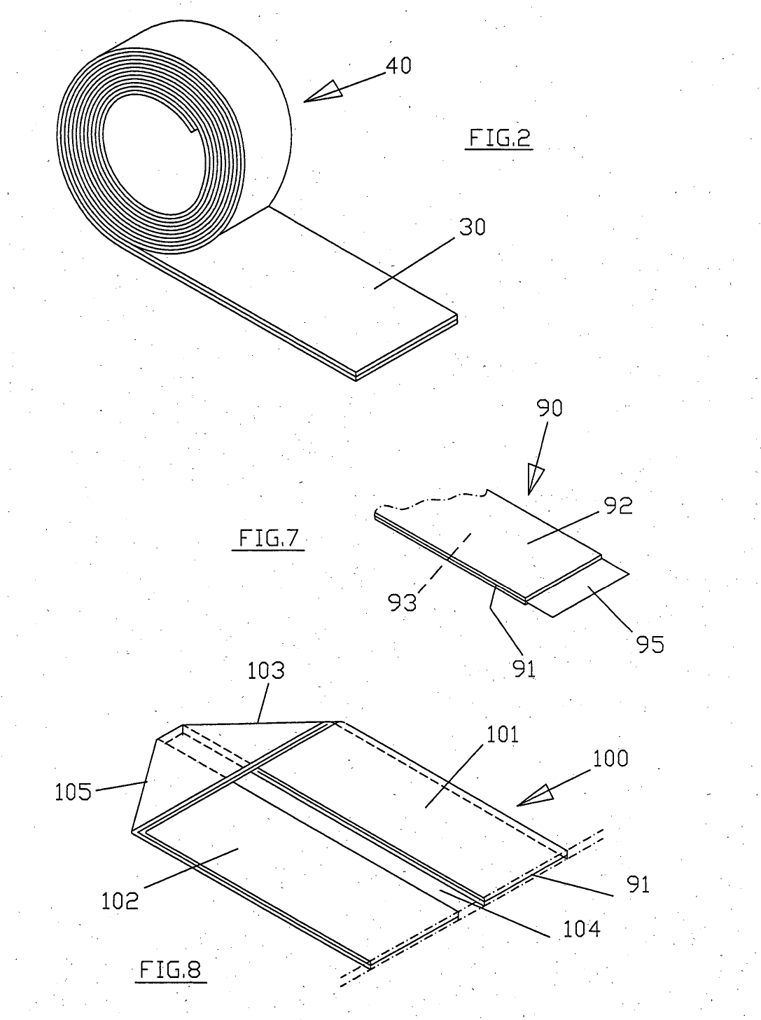

FIG. 2 A reel of the strip subject of the invention, perspective.

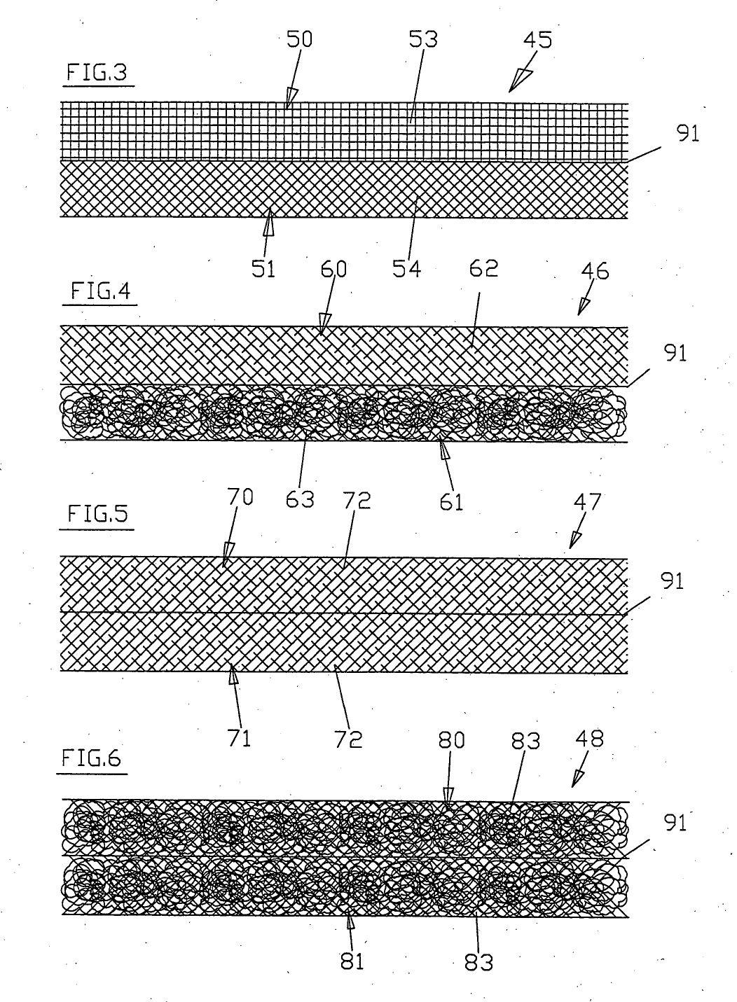

FIG. 3 Enlarged cross section of the strip having a reinforcement impregnated with plastomer polymer-bitumen on one face and with elastomer polymer-bitumen on the other face.

FIG. 4 Enlarged cross section of the strip showing a reinforcement of fibreglass on one face and one of spunbonded fabric on the other, impregnated with plastomer polymer-bitumen.

FIG. 5 Enlarged cross section of the strip with a fibreglass reinforcement impregnated with plastomer polymer-bitumen.

FIG. 6 Enlarged cross section of the strip with a spunbonded fabric reinforcement impregnated with plastomer polymer-bitumen.

FIG. 7 A length of strip after removal, using heat and mechanical means, of layers of polymer-bitumen at one end, perspective.

FIG. 8 A length of strip with a double bend at 45°.

FIG. 9 A thermoelectric layer formed of several U-shaped lengths of strip placed side by side.

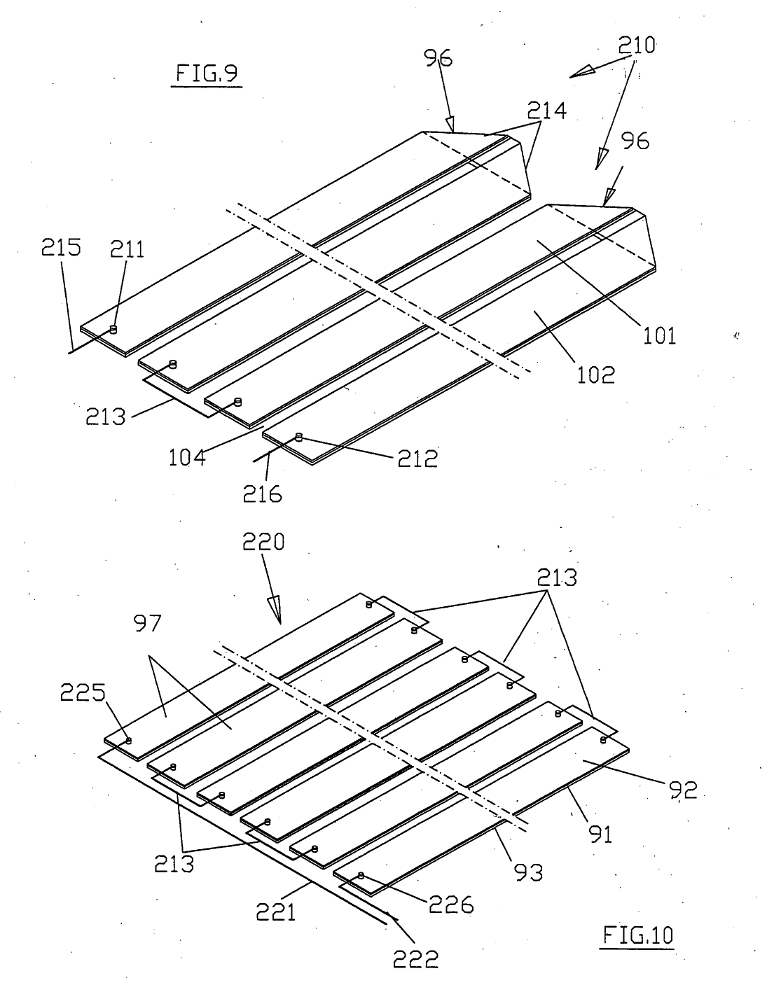

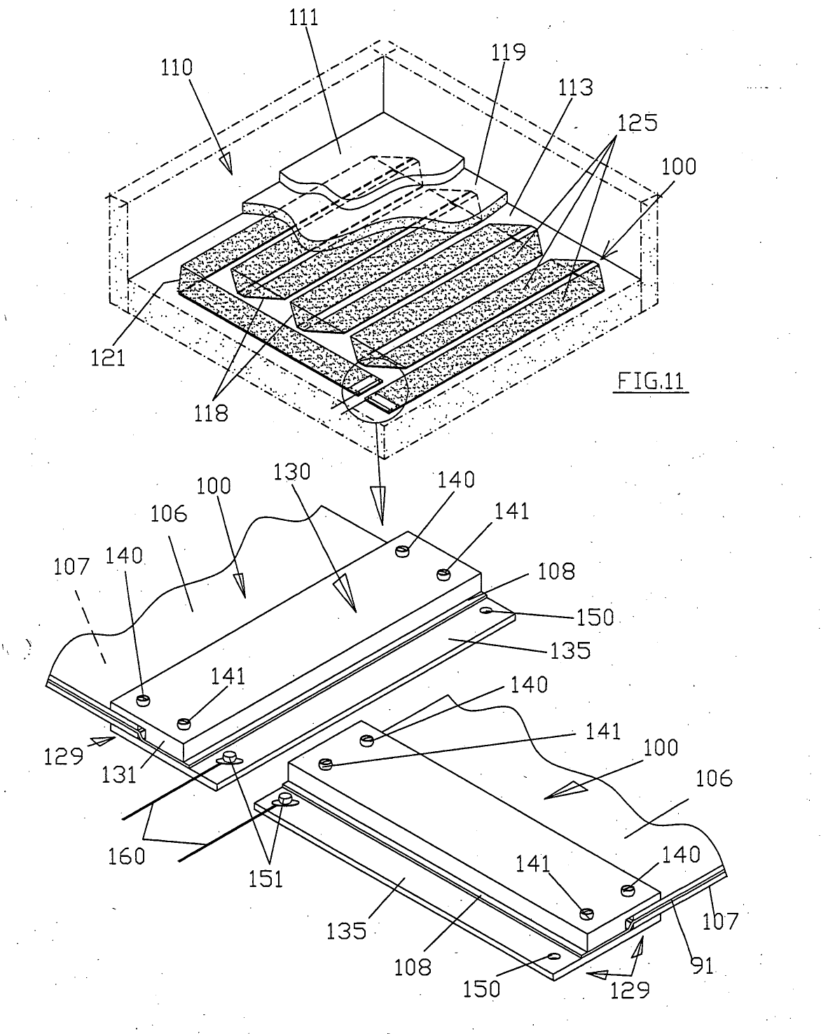

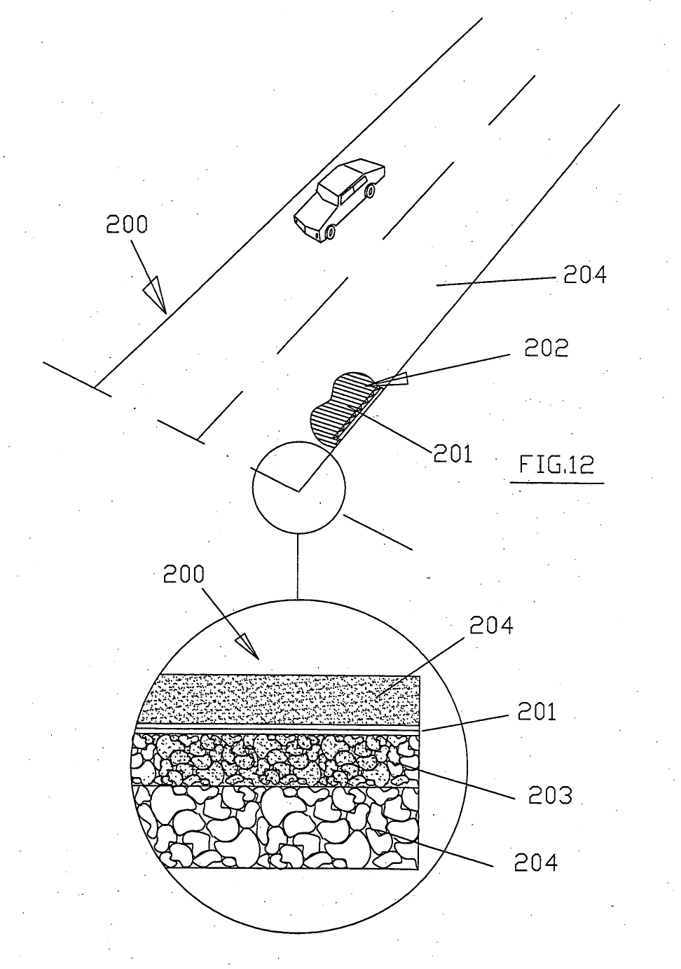

FIG. 10 A thermoelectric layer formed of several lengths of strip laid side by side.

FIG. 11 An indoor room heated electrically by a thermoelectric layer consisting of a serpentine of strip, perspective with detail. FIG. 12 A roadway with electric heating under the paving blanket obtained by a thermoelectric layer consisting of a serpentine of the strip, perspective.

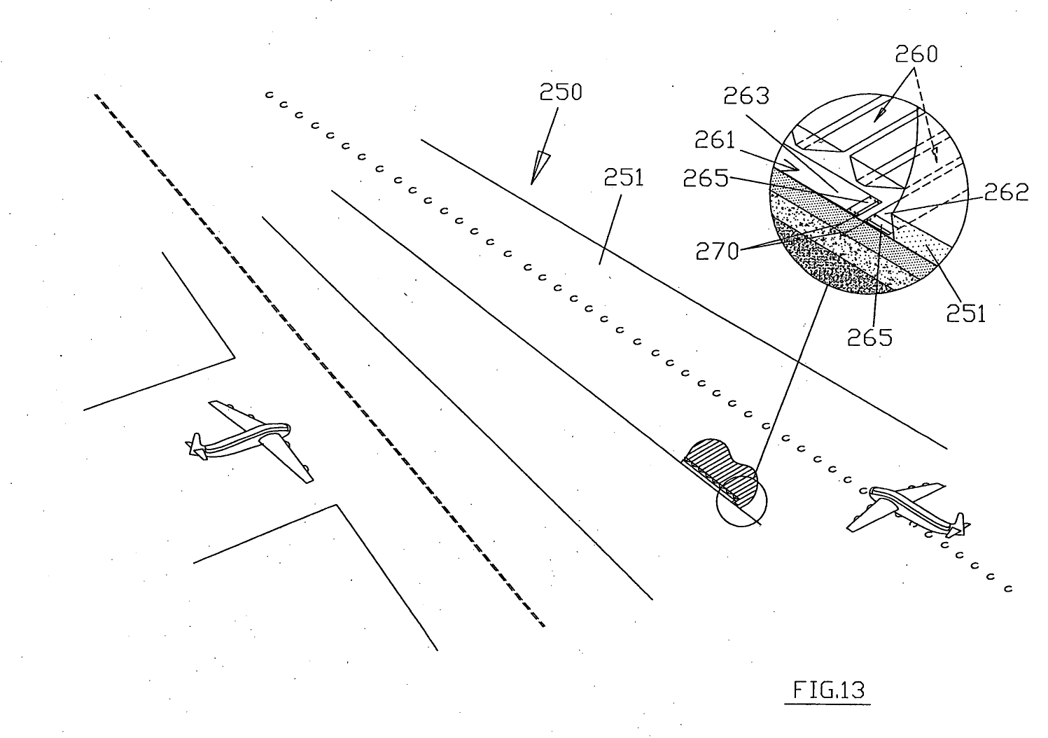

FIG. 13 An airport runway electrically heated with a thermoelectric layer consisting of a serpentine of the strip, perspective with detail.

The installation 10 for producing the strip subject of the invention comprises a structure 11 in which a polymer-bitumen membrane 20 with a metalcore is produced. The tower 12 can be seen with a set of rollers 15 for drying the membrane 20 and the front plate 16 with a pair of terminal rollers 18. from which the membrane 20 emerges.

On emerging from the rollers 18, the membrane 20 passes into the cutter 25 with shears 26 that cut it into strips 30.

The installation is run entirely from a computer inside the box-shaped unit 17 on which is a control and programming panel 19.

The strips 30 are wound into reels 40 (FIG. 2) on a structure downstream not shown in the drawing.

The installation contains all equipment, needed to produce membranes 20 as required, and therefore strips 30, 45-48 with a metal core this being of aluminium 91 of a constant section and of micrometric thickness, interposed between two layers of polymer-bitumen.

FIG. 3 shows a strip 45 with a layer 50 of elastomer polymer-bitumen and fibreglass reinforcement 53, and a layer 51 of plastomer polymer-bitumen with reinforcement 54.

FIG. 4 shows a strip 46 with a layer 60 of plastomer polymer-bitumen with fiberglass reinforcement 62 and a layer 61 of plastomer polymer-bitumen with a spunbonded reinforcement 63.

FIG. 5 shows a strip 47 with layers 70 and 71 of plastomer polymer-bitumen with a fibreglass reinforcement 72.

FIG. 6 shows a strip 48 with layers 80 and 81 of plastomer polymer-bitumen and a spunbonded reinforcement 83.

FIG. 7 shows a length 90 of strip 30 with a metal core 91 sunk between two layers 92, 93 of polymer-bitumen.

At the end 95 of said core the layers of bitumen have been cleaned off by heat and mechanical means.

FIG. 8 shows a length 100 of a strip 30 with metal core 91 bent in two places 103 and 105 at 45° from the axis. The spacing 104 serves to maintain electrical insulation between the two bends 101 and 102 in the strip.

FIG. 9 shows a thermoelectric layer 210 consisting of several U-shaped lengths of a strip 30 with a double bend 214 at 45°, placed side by side and electrically connected by a bridge 213 and terminals 211, 212 for electric wiring 215, 216.

FIG. 10 illustrates a thermoelectric layer 220consisting of lengths 97 of strips 30 placed side by side and electrically connected by bridges 213 to the electric wires 221 and 222 fixed to the terminals 225 and 226.

FIG. 11 illustrates a room 110 in the base of whose floor 113 is a thermoelectric layer 125 formed of a serpentine 100 of the strip 30 with its metal core 91 placed between two layers 106, 107 of polymer-bitumen.

The serpentine is formed by making a couple of bends 118 at 45°.

A coat 111 of mortar 119 is laid over said thermoelectric layer 125.

By means of the bend 121 at 45°, the final end of the serpentine 100 of strip 30 reaches nearly to the starting end of said serpentine.

The ends of the strip have been cleaned of the layers 106 and 107 of polymer-bitumen as shown in FIG. 7, leaving the ends of the core 91 exposed.

The ends of the core 91 are held firm by the clamps 129 for electrical connection, said clamps consisting of metal plates 130 and 135 for electric contact.

One longitudinal part 131 of the plate 130 is thicker than the other part by a difference equivalent to the thickness of the strip.

Thickness of the plate 135 is constant but it is wider than plate 130.

The plates 130, 135 can therefore be held by rivets 140 onto the serpentine 100, and by rivets 141 to the metal core 91.

The holes 150 in the projecting part of the plate 35 serve for the screws 151 to fix the electric wires 160.

FIG. 12 shows how a road 200 can be heated by a thermoelectric layer 201, similar to the layer 125 described in FIG. 11, consisting of a serpentine 202 of the strip 30 laid beween the base 202, 203 and the paving blanket 204. Heating the road will be found of great use in cases of fog, icing and other difficult climatic situations.

FIG. 13 illustrates an airport runway 250 under whose paving 251 is a thermoelectric layer 260 similar to the layer 125 described above (FIG. 11), consisting of a serpentine 261. The ends 262, 263 of the serpentine are connected by terminals 265 to the electric cables 270.

Heating the runway paving blanket 251 in this way prevents formation of fog and icing.

1. Process for surface and environmental heating of building structures and infrastructures, characterized by formation of a thermoelectric layer (125, 201, 210, 220, 260) behind the cladding of walls and especially underneath the floor paving (111, 204, 251) of the building structures (110) and infrastructures (200, 250) created by lengths, laid side by side at a distance (104) sufficient for electric insulation, of a bitumen-based strip (30, 45-48), with a metal core (91) of extremely high electrical conductivity, of a constant section and of micrometric thickness between two layers (50,51) (60,61) (70,71) (80,81) (92,93) (106,107) of the bitumen-based product, which core being closed in an electric circuit, determines transformation of electric energy into thermal energy.

2. Process for surface or environmental heating of building structures and infrastructures, as in claim 1, characterized in that the pieces laid side by side are obtained by turning a length (100) of strip (30, 45-48) back on itself at 45° in relation to its axis, so as to form a quadrangular spiral.

3. Process for surface or environmental heating of building structures and infrastructures, as in claim 1, characterized in that the pieces laid side by side are obtained by turning back a length (100) of the strip (30, 45-48) on itself, with a double bend at 45° (103-105, 108) in relation to its axis, so as to form a serpentine.

4. Process for surface or environmental heating of building structures and infrastructures, as in claim 3, characterized in that the last section of the length (100) of the strip (30, 45-48) presents a bend (121) turning back on itself at 45° and presents its final end at a short distance from its starting end so facilitating connection to the source of electric current.

5. Process for surface or environmental heating of building structures and infrastructures, as in claim 1, characterized in that the pieces of strip (30, 45-48) laid side by side are obtained from lengths (97) of the strip electrically connected in parallel or in series.

6. Process for surface or environmental heating of building structures and infrastructures, as in claim 1, characterized in that the pieces of strip (30, 45-48) laid side by side and obtained from U-shaped pieces (96) of said strip formed by a double bend (214) at 45°, are electrically connected in parallel or in series.

7. Process for surface or environmental heating of building structures and infrastructures, as in claim 1, characterized in that connection of the ends (95) of the metal core (91) of the thermoelectric layer (125, 201, 210, 220, 260) obtained with the lengths of the strip (30, 45-48), to the source of electric current, is made possible by removing, from said ends (95) of the metal core, the bituminous layers (50,51), (60,61) (70,71) (80,81) (92,93) (106,107) by the action of heat and mechanical means.

8. Process for surface or environmental heating of building structures and infrastructures, as in claim 7, characterized in that the ends (95) of the metal core (91) of the strip (30, 45-48) composing the thermoelectric layer (125, 201, 210, 220, 260) are electrically connected by applying to said ends an oblong clamping means (124) formed of a pair of rectangular metal plates (130, 135), the first (130) comprising approximately one longitudinal half (131) of a thickness greater to an extent substantially corresponding to the thickness of the strip, and the second plate (135) of a constant thickness but wider than the first, it being thus possible to apply said clamping means (124) to the ends of the strip with rivets (140, 141) or their equivalent, simultaneously making that part of the strip (30, 45-48) comprising the bitumen based product correspond to the longitudinal area of lesser thickness of the first plate (130) and core (91) of said strip to the longitudinal area of greater thickness of said first plate (130), one of the plates presenting a projecting part with a hole (150) for connection by a terminal (151) to the electric wire (160).

9. Process for surface or environmental heating of building structures and infrastructures as in claim 1, characterized in that the strip (30, 45-48) with bitumen-based product is obtained by applying the product on a impregnable reinforcement (53,54) (62,63) (72, 83) to each face of the metal core (91).

10. Process for surface or environmental heating of building structures and infrastructures as in claim 9, characterized in that the reinforcement (54) is of polyester fibre on one face of the metal core (91) and of fibregass (53) on the other face.

11. Process for surface or environmental heating of building structures and infrastructures as in claim 9, characterized in that the reinforcement (72) is of fibreglass on both faces of the metal core (91).

12. Process for surface or environmenal heating of building structures and infrastructures as in claim 9, characterized in that the reinforcement (83) is of spunbonded fabric on both faces of the metal core (91).

13. Process for surface or environmental heating of building structures and infrastructures as in claim 9, characterized in that the reinforcement is of fibreglass (62) on one face and of spunbonded fabric (63) on the other face of the metal core (91)

14. Process for surface or environmental heating of building structures and infrastructures as in claim 1, characterized in that the bitumen is a polymer bitumen.

15. Process for surface or environmental heating of building structures and infrastructures as in claim 1, characterized in that the bitumen is associated to elastomers.

16. Process for surface or environmental heating of building structures and infrastructures as in claim 1, characterized in that the bitumen is associated to plastomers.

17. Process for surface or environmental heating of building structures and infrastructures as in claim 1, characterized in that the electric power applied is comprised between 30 and 50 Watt/m².

18. Process for surface or environmental heating of building structures and infrastructures as in claim 1, characterized in that applied voltage does not exceed 12 Volts.

19. Process for surface or environmental heating of building structures and infrastructures as in claim 1, characterized in that the metal core (91) is connected to the source of electric current through a computer for programming and automating, in the area relating to the structures (110) and infrastructures (200, 250), application of the temperatures and heating times most suited to prevailing environmental conditions.

20. Process for surface or environmental heating of building structures and infrastructures as in claim 1, characterized in that the thermoelectric layer (125) is applied underneath the flooring (111) of indoor rooms (110).

21. Process for surface or environmental heating of building structures and infrastructures as in claim 1, characterized in that the thermoelectric layer (260) is applied underneath the paving blanket (204) of the runways (251) of airports (250).

22. Process for surface or environmental heating of building structures and infrastructures as in claim 1, characterized in that the thermoelectric layer (201) is applied underneath the paving blanket (204) of roads (200) in general whether in the open air or in tunnels.

23. Process for surface or environmental heating of building structures and infrastructures as in claim 1, characterized in that the thermoelectric layer is applied under the tiles and roofing in general of buildings.

24. Process for surface or environmental heating of building structures and infrastructures as in claim 1, characterized in that the thermoelectric layer is inserted under the earth of plants forming the grassy surface of football fields.

25. Process for surface or environmental heating of building structures and infrastructures as in claim 1, characterized in that the thickness of the thermoelectric layer (125, 201, 210, 220, 260) is comprised between two and four millimetres.

26. Process for surface or environmental heating of building structures and infrastructures as in claim 1, characterized in that the metal core (91) is of aluminium.

27. Process for surface or environmental heating of building structures and infrastructures as in claim 1, characterized in that the metal core (91) is of copper.

28. Strip (30, 45-48) of polymer-bitumen as in claims 9-16, 25-27.

29. Plant (10) for the production of strips (30, 45-48) of polymer-bitumen as in claims 9-16, 25-27, 28.
